(19) United States
(12) Patent Application Publication
(10) Pub. No.: US 2026/0176120 A1
(43) Pub. Date: Jun. 25, 2026

(54) CONTROLS OF WORK VEHICLES INCLUDING PEDESTRIAN DETECTION SYSTEMS

(71) Applicant: UNITED STATES GYPSUM COMPANY, Chicago, IL (US)

(72) Inventor: Ronald John Koval, Aurora, IL (US)

(21) Appl. No.: 19/374,004

(22) Filed: Oct. 30, 2025

Related U.S. Application Data
(60) Provisional application No. 63/736,013, filed on Dec. 19, 2024.

(51) Int. Cl. B66F 17/00

(52) U.S. Cl. CPC B66F 17/003

(57) ABSTRACT

A work vehicle includes an operator seat and a seat sensor configured to provide a first signal in response to presence of an operator seated in the operator seat. A pedestrian detection system includes an electronic controller operatively coupled with one or more sensors. The pedestrian detection system is configured to detect presence of a pedestrian in proximity to the work vehicle. A controllable switch device operatively coupled with the seat sensor and the pedestrian detection system. The controllable switch device is configured to provide a second signal to activate the pedestrian detection system in response to the first signal provided by the seat sensor.

### CROSS-REFERENCE

The present disclosure claims the benefit of and priority to U.S. Application No. 63/736,013 filed Dec. 19, 2025, and the same is hereby incorporated by reference.

### TECHNICAL FIELD

The present disclosure relates to controls of work vehicles including pedestrian detection systems and to related apparatuses, processes, and systems.

### BACKGROUND

A number of proposals have been made to provide safety systems for work vehicles. Existing proposals suffer from a number of drawbacks, disadvantages, and unmet needs. Existing proposals may, for example, including an auxiliary system including cameras or other sensors configured to detect pedestrians. During some operating modes, such auxiliary systems may be unavailable, for example, due to time needed for initialization and start up of such systems. There remains a significant unmet need for the unique apparatuses, processes, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some example embodiments include unique systems for work vehicles. Some example embodiments include unique processes for work vehicles. Some example embodiments include unique apparatuses for work vehicles. Further embodiments, forms, objects, features, advantages, aspects, and benefits shall become apparent from the following description and drawings.

### BRIEF DESCRIPTION OF THE DRAWINGS

FIG. 1 is a schematic diagram depicting certain aspects of an example work vehicle system.

FIG. 2 is a schematic diagram depicting certain aspects of one form of the example work vehicle system.

FIG. 3 is a schematic diagram depicting certain aspects of another form of the example work vehicle system.

FIG. 4 is a schematic diagram depicting certain aspects of the example work vehicle system.

FIG. 5 is a flow diagram depicting certain aspects of an example process.

FIG. 6 is a flow diagram depicting certain aspects of an example process.

### DETAILED DESCRIPTION OF EXAMPLE EMBODIMENTS

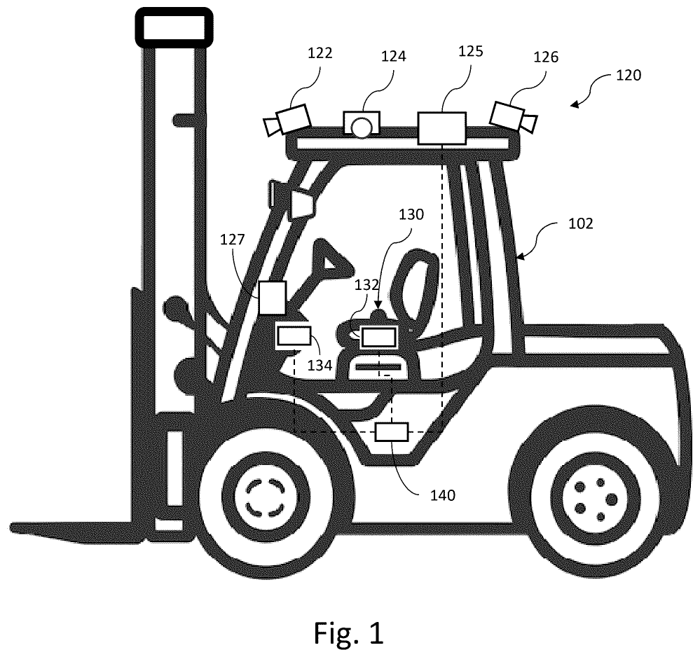

Referring now to the drawings and with initial reference to FIG. 1, there is illustrated an example work vehicle system 100 including a work vehicle 102. In the illustrated example, work vehicle 102 is configured and provided as a forklift. In other embodiments, work vehicle 102 may be configured and provided in other forms such as a loader, a hauler, picker, or other types of industrial vehicles as will occur to one of skill in the art with the benefit and insight of the present disclosure.

Work vehicle 102 comprises an operator seat 130 configured to accommodate and support an operator of work vehicle 102 in a seated position, a seat sensor 132, and a key switch 134. Seat sensor 132 is configured to provide a seat sensor signal in response to presence of an operator seated in the operator seat. The seat sensor signal may comprise any of a number of forms including, for example, a voltage level indicating presence of an operator seated in the operator seat which may be either a high voltage level or a low voltage level depending on the configuration of the seat sensor or another type of signal as will occur to one of skill in the art with the benefit and insight of the present disclosure. In the illustrated example, seat sensor 132 is configured and provided as a seat switch such as an electro mechanical switch such as a plunger switch, a transducer such as a pressure transducer or force transducer, a hall effect switch, a piezo switch, or other types of switches as will occur to one of skill in the art with the benefit and insight of the present disclosure.

Work vehicle 102 comprises a pedestrian detection system 120 comprising an electronic controller 125 operatively coupled with one or more sensors 122, 124, 126. The illustrated example, pedestrian detection system is configured as a camera-based detection and the more sensors 122, 124, 126 comprise cameras and electronic controller 125 is configured to process inputs received from the more sensors 122, 124, 126 and detect presence of a pedestrian proximate work vehicle 102. Other embodiments may additionally or alternatively utilize other types of sensors may be utilized such as proximity sensors, RADAR sensors, LIDAR sensors, or other types of operator perceptible outputs as will occur to one of skill in the art with the benefit and insight of the present disclosure.

Pedestrian detection system 120 is configured to detect presence of a pedestrian in proximity to the work vehicle and, in response to such detection, provide one or more operator perceptible outputs via one or more output devices 127. Such alerts or alarms may comprise lights or other visually perceptible outputs or alarms, sirens or other audible outputs, vibration or other haptic outputs or other types of operator perceptible outputs as will occur to one of skill in the art with the benefit and insight of the present disclosure. In some embodiments, pedestrian detection system 120 may be configured to actuate, operate, or trigger an accident avoidance or collision avoidance system such as a power kill system or emergency braking system.

Work vehicle 102 comprises a controllable switch device 140 operatively coupled with seat sensor 132 and pedestrian detection system 120. Controllable switch device 140 is configured to provide an activation signal to activate pedestrian detection system 120 in response to the seat sensor signal provided by seat sensor 132. In the illustrated example, controllable switch device 140 is configured and provided as a programmable relay. In other embodiments, controllable switch device 140 may be configured and provided in other forms such as another type of relay or a more sophisticated electronic device such as an application specific integrated circuit, microcontroller, or other integrated circuit device.

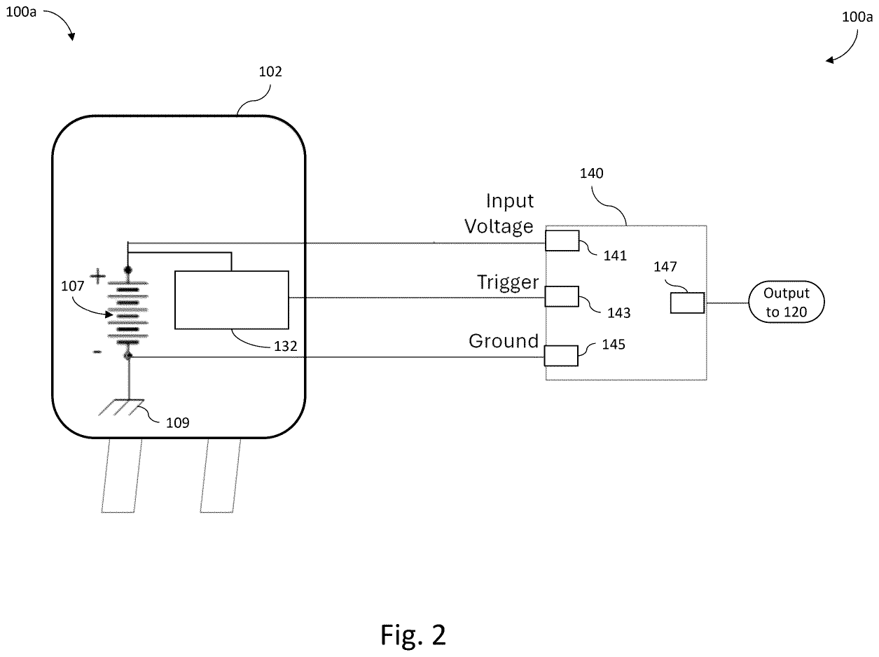

With reference to FIG. 2, there is illustrated an example embodiment 100a of work vehicle system 100. In embodiment 100a, controllable switch device 140 includes voltage input 141 which is operatively coupled with a positive terminal of a battery 107, a trigger inputs 143 which is operatively coupled with an output side of seat sensor 132, and a ground input 145 which is operatively coupled with chassis ground 109. An input side of seat sensor 132 is also operatively coupled with the positive terminal of a battery 107. A negative terminal of battery 107 is also operatively coupled with chassis ground.

Controllable switch device 140 includes output 147 which is configured to provide the activation signal to pedestrian detection system 120. The activation signal may comprise a number of types of signals such as a positive voltage, a power-on signal, a wake-up signal, or other types of activation signals as will occur to one of skill in the art with the benefit and insight of the present disclosure. Controllable switch device 140 may be configured to provide the activation signal without requiring a key on state of key switch 134. Controllable switch device 140 may be configured to provide the activation signal without requiring any other state or condition of work vehicle 102 or work vehicle system 100.

During an example operating scenario of embodiment 100a, an operator may enter work vehicle 102 and sit on seat 130 effective to actuate seat sensor 132. Seat sensor 132, provides a seat sensor signal to controllable switch device 140. Controllable switch device 140, in turn, outputs an activation signal to pedestrian detection system 120 effective to power-on, wake-up, or otherwise activate pedestrian detection system 120. The activation signal may remain present (or remain transmitted) during such time as seat sensor 132 provides the seat sensor signal in response to the operator sitting on seat 130. When the operator leaves seat 130, seat sensor 132 is not actuated and stops supplying the seat sensor signal. Thereafter, controllable switch device 140 stops outputting the activation signal to pedestrian detection system 120 which may be effective to power-off, put to sleep, or otherwise deactivate or inactivate pedestrian detection system 120 and/or to allow or permit such powering-off, putting to sleep, or other deactivation or inactivation of pedestrian detection system 120. Controllable switch device 140 may be configured to provide the activation signal during such time as the seat sensor 132 provides the seat sensor signal and for a predetermined duration after such time, for example, one second or another delay duration. This may provide a rationality check on the actuation signal provided by seat sensor 132 and mitigates the possibility of inadvertent deactivation or inactivation pedestrian detection system 120 which could otherwise occur, for example, due to a temporary weight shifting of the operator that can momentarily de-actuate seat sensor 132.

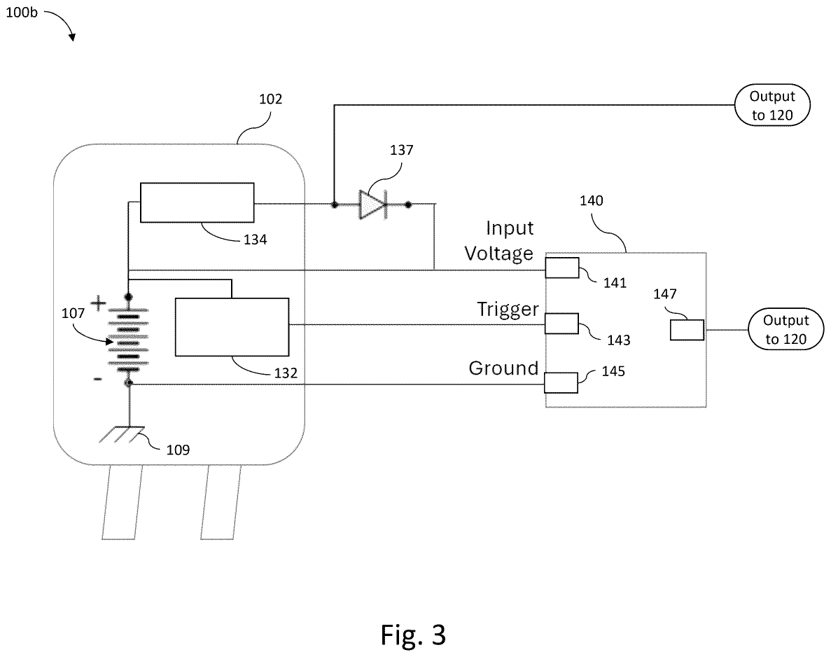

With reference to FIG. 3, there is illustrated an example embodiment 100b of work vehicle system 100. Embodiment 100b includes a number of features and attributes of example embodiment 100a which are illustrated and designated with the same reference numerals utilized in FIG. 2 and it shall be appreciated that the description of such features also generally applies to embodiment 100b of FIG. 3. Embodiment 100b also includes other features varying from example embodiment 100a.

In embodiment 100b, an input side of key switch 134 is operatively coupled with the positive terminal of a battery 107 an output side of key switch 134 is operatively coupled with pedestrian detection system 120. Thus, in an on state or position key switch 134 is configured to provide an additional activation signal to pedestrian detection system 120. The additional activation signal may comprise any of the types of actuation signals described in connection with controllable switch device 140 and may be of the same type or a different type as the actuation signal provided controllable switch device 140. The additional activation signal may be configured and effective to activate, maintain activation of, or inhibit deactivation of pedestrian detection system 120.

In embodiment 100b, controllable switch device 140 is configured to provide the activation signal as a one-shot signal with a predetermined duration and a reset time. The reset time may be selected such that controllable switch device 140 is configured to provide the activation signal for a predetermined duration after initiation of the activation signal. The

In embodiment 100b, an output side of key switch 134 is also operatively coupled with voltage input 141 of controllable switch device 140 effective to provide a common voltage at this node. This may be effective to mitigate the transient effects that may occur when key switch 134 is turned on or off. Diode 137 provides reverse blocking effective to isolate other systems and equipment such as displays and other loads of work vehicle 102 that are coupled with the output side of key switch 134.

During an example operating scenario of embodiment 100b, an operator may enter work vehicle 102 and sit on seat 130 effective to actuate seat sensor 132. Seat sensor 132, provides a seat sensor signal to controllable switch device 140. Controllable switch device 140, in turn, outputs a one-shot activation signal to pedestrian detection system 120 effective to power-on, wake-up, or otherwise activate pedestrian detection system 120. The one-shot activation signal may remain present (or remain transmitted) for a predetermined time. The operator may thereafter operate key switch 134 to turn on effective to provide a second activation signal that will maintain activation of or inhibit deactivation of pedestrian detection system 120. Thus, pedestrian detection system 120 will remain activated unless and until the operator operates key switch 134 and the one-shot activation signal is no longer present after the predetermined time has elapsed. The pedestrian detection system 120 may be powered-off, put to sleep, or otherwise deactivated or inactivated and/or such powering-off, putting to sleep, or other deactivation or inactivation of pedestrian detection system 120 may be allowed or permitted. This may provide mitigate an unintended operating scenario wherein an operator has turned off work vehicle 102 and is approached by a pedestrian unnecessarily triggering an alert or alarm.

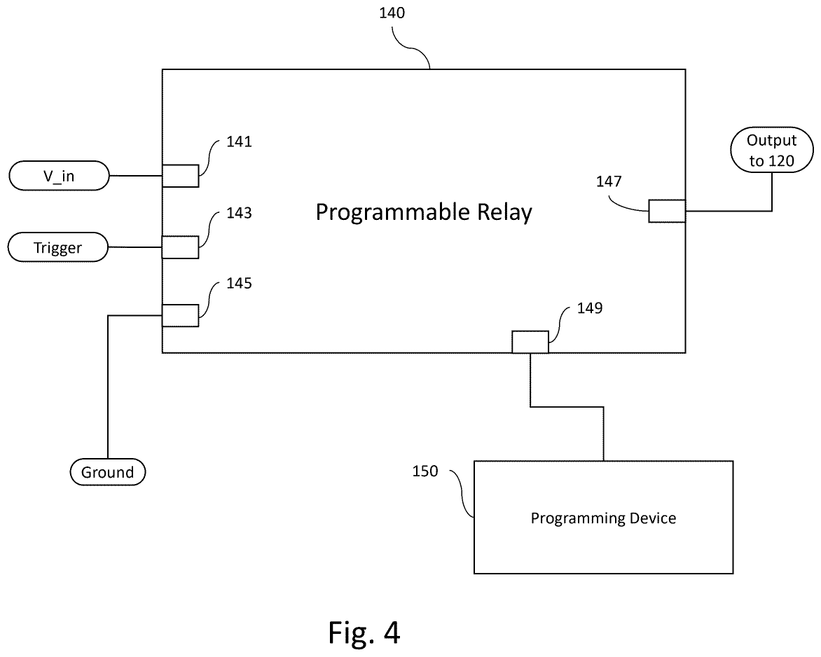

With reference to FIG. 4, there is illustrated an example a programming device 150 which is operatively coupled with a programming I/O interface 149 of controllable switch device 140. Programming device 150 may be configured and operable to program the controllable switch device 140 to configure it with the features and functionality described herein and/or to vary or set trims or operational parameters thereof, such as by adjusting delay times or on predetermined on times. In some instances, programming device 150 may be provided and utilized only during the configuration of controllable switch device 140 in either an installed state or an uninstalled state. In some instances, programming device 150 may be provided and utilized in an installed state of controllable switch device 140 to vary operation thereof.

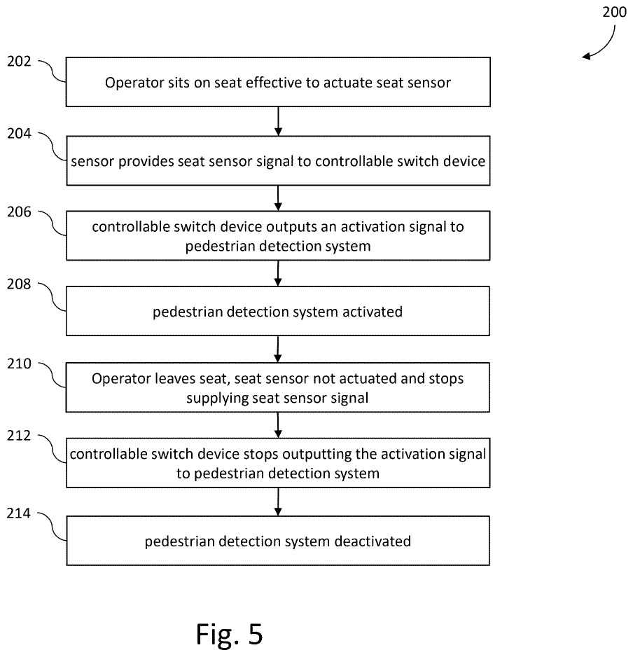

With reference to FIG. 5, there is illustrated an example process 200 which may be performed during an example operating scenario of embodiment 100a. Process 200 may be initiated at operation 202 at which an operator may enter work vehicle 102 and sit on seat 130 effective to actuate seat sensor 132. From operation 202, process 200 proceeds to operation 204 at which seat sensor 132 provides a seat sensor signal to controllable switch device 140.

From operation 204, process 200 proceeds to operation 206 at which controllable switch device 140 outputs an activation signal to pedestrian detection system 120 in response to the seat sensor signal. The activation signal may remain present (or remain transmitted) during such time as seat sensor 132 provides the seat sensor signal in response to the operator sitting on seat 130. From operation 206, process 200 proceeds to operation 208 at which pedestrian detection system 120 powers-on, wakes-up, or is otherwise activated in response to the activation signal.

From operation 208, process 200 proceeds to operation 210 at which the operator leaves seat 130, seat sensor 132 is no longer actuated and stops supplying the seat sensor signal. From operation 210, process 200 proceeds to operation 212 at which controllable switch device 140 stops outputting the activation signal to pedestrian detection system 120 in response to the absence of the seat sensor signal. From operation 210, process 200 proceeds to operation 214 at which pedestrian detection system 120 powers-off, is put to sleep, or is otherwise deactivated or inactivated and/or to is allowed or permitted to undergo such powering-off, putting to sleep, or other deactivation or inactivation of pedestrian detection system 120.

In some forms of process 200, controllable switch device 140 may be configured to provide the activation signal during such time as the seat sensor 132 provides the seat sensor signal and for a predetermined duration after such time, for example, one second or another delay duration. This may provide a rationality check on the actuation signal provided by seat sensor 132 and mitigates the possibility of inadvertent deactivation or inactivation pedestrian detection system 120 which could otherwise occur, for example, due to a temporary weight shifting of the operator that can momentarily de-actuate seat sensor 132.

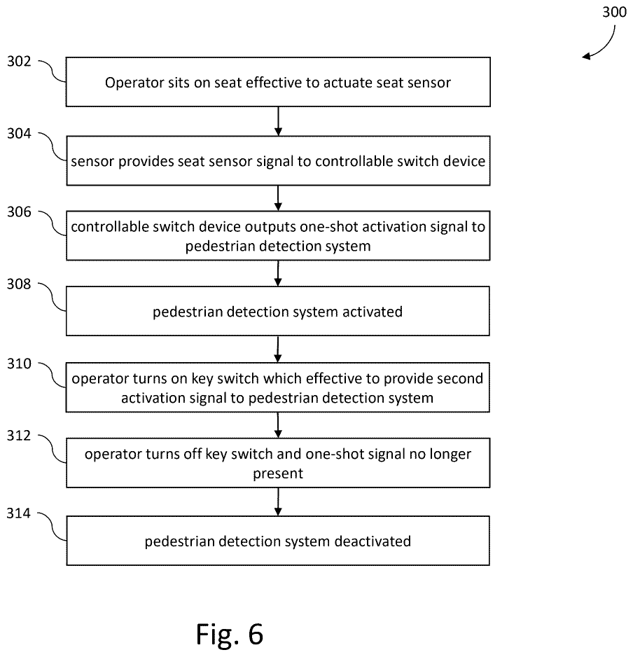

With reference to FIG. 6, there is illustrated an example process 300 which may be performed during an example operating scenario of embodiment 100b. Process 300 may be initiated at operation 302 at which an operator may enter work vehicle 102 and sit on seat 130 effective to actuate seat sensor 132. From operation 302, process 300 proceeds to operation 304 at which seat sensor 132 provides a seat sensor signal to controllable switch device 140.

From operation 304, process 300 proceeds to operation 306 at which controllable switch device 140 outputs a one-shot activation signal to pedestrian detection system 120 in response to the seat sensor signal. The one-shot activation signal may remain present (or remain transmitted) for a predetermined time. From operation 306, process 300 proceeds to operation 308 at which pedestrian detection system 120 powers-on, wakes-up, or is otherwise activated in response to the one-shot activation signal.

From operation 308, process 300 proceeds to operation 310 at which the operator operates key switch 134 to turn on effective to provide a second activation signal to pedestrian detection system 120. The second activation signal may be effective to maintain activation of or inhibit deactivation of pedestrian detection system 120. Thereafter, the pedestrian detection system 120 may remain activated unless and until the operator turns off key switch 134 and the one-shot activation signal is no longer present after the predetermined time has elapsed.

From operation 310, process 300 proceeds to operation 312 at which the operator turns off key switch 134 and the predetermined time for the one-shot timer has elapsed. From operation 310, process 300 proceeds to operation 314 at which pedestrian detection system 120 powers-off, is put to sleep, or is otherwise deactivated or inactivated and/or to is allowed or permitted to undergo such powering-off, putting to sleep, or other deactivation or inactivation of pedestrian detection system 120.

Example embodiment 1 is a system comprising: a work vehicle comprising an operator seat and a seat sensor configured to provide a first signal in response to presence of an operator seated in the operator seat; a pedestrian detection system comprising an electronic controller operatively coupled with one or more sensors, the pedestrian detection system configured to detect presence of a pedestrian in proximity to the work vehicle; and a controllable switch device operatively coupled with the seat sensor and the pedestrian detection system, the controllable switch device configured to provide a second signal to activate the pedestrian detection system in response to the first signal provided by the seat sensor.

Example embodiment 2 includes the features of example embodiment 1, wherein the controllable switch device is configured to provide the second signal without requiring a key on state of the work vehicle.

Example embodiment 3 includes the features of example embodiment 1, wherein the controllable switch device is configured to provide the second signal during such time as the seat sensor provides the first signal and for a predetermined duration after such time.

Example embodiment 4 includes the features of example embodiment 1, wherein the work vehicle comprises a key switch operatively coupled with the controllable switch device and configured to provide a third signal to the pedestrian detection system.

Example embodiment 5 includes the features of example embodiment 4, wherein the controllable switch device is configured to provide the second signal as a one-shot signal.

Example embodiment 6 includes the features of example embodiment 5, wherein the controllable switch device is configured to provide the second signal for a predetermined duration after initiation of the one-shot signal.

Example embodiment 7 includes the features of example embodiment 4, wherein a reverse blocking diode is provided intermediate the key switch and the controllable switch device.

Example embodiment 8 includes the features of example embodiment 1, wherein the controllable switch device comprises a relay.

Example embodiment 9 includes the features of example embodiment 8, wherein the relay comprises a programmable relay.

Example embodiment 10 includes the features of example embodiment 1, wherein the seat sensor comprises a seat switch.

Example embodiment 11 includes the features of example embodiment 1, wherein the work vehicle comprises a forklift.

Example embodiment 12 is a process comprising: providing a system comprising a work vehicle including an operator seat and a seat sensor configured to sense presence of an operator seated in the operator seat, a pedestrian detection system including an electronic controller operatively coupled with one or more sensors and configured to detect presence of a pedestrian in proximity to the work vehicle, and a controllable switch device operatively coupled with the seat sensor and the pedestrian detection system; providing a first signal from the seat sensor to the controllable switch device in response presence of an operator seated in the operator seat; providing a second signal from the controllable switch device to the pedestrian detection system in response to the first signal; and activating the pedestrian detection system in response to the second signal.

Example embodiment 13 includes the features of example embodiment 12, wherein the providing the second signal from the controllable switch device occurs in absence of a key on state of the work vehicle.

Example embodiment 14 includes the features of example embodiment 12, wherein the providing the second signal from the controllable switch device occurs during such time as the seat sensor provides the first signal and for a predetermined duration after such time.

Example embodiment 15 includes the features of example embodiment 12, comprising:
providing a third signal from a key switch of the work vehicle to the pedestrian detection system.

Example embodiment 16 includes the features of example embodiment 15, wherein the second signal comprises a one-shot signal.

Example embodiment 17 includes the features of example embodiment 16, comprising providing the one-shot signal from the controllable switch device for a predetermined duration after initiation of the one-shot signal.

Example embodiment 18 includes the features of example embodiment 15, comprising providing a reverse blocking diode intermediate the key switch and the controllable switch device.

Example embodiment 19 includes the features of example embodiment 12, wherein the seat sensor comprises a seat switch.

Example embodiment 20 includes the features of example embodiment 12, wherein the work vehicle comprises a forklift.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise indicated. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language herein, is intended merely to better illuminate the invention and does not pose a limitation on the scope of the invention unless otherwise claimed. No language in the specification should be construed as indicating any non-claimed element as essential to the practice of the invention. When the language “at least a portion” and/or “a portion” is used the item can include a portion and/or the entire item unless specifically stated to the contrary. Furthermore, use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow.

What is claimed is:

1. A system comprising:
a work vehicle comprising an operator seat and a seat sensor configured to provide a first signal in response to presence of an operator seated in the operator seat;
a pedestrian detection system comprising an electronic controller operatively coupled with one or more sensors, the pedestrian detection system configured to detect presence of a pedestrian in proximity to the work vehicle; and
a controllable switch device operatively coupled with the seat sensor and the pedestrian detection system, the controllable switch device configured to provide a second signal to activate the pedestrian detection system in response to the first signal provided by the seat sensor.

2. The system of claim 1, wherein the controllable switch device is configured to provide the second signal without requiring a key on state of the work vehicle.

3. The system of claim 1, wherein the controllable switch device is configured to provide the second signal during such time as the seat sensor provides the first signal and for a predetermined duration after such time.

4. The system of claim 1, wherein the work vehicle comprises a key switch operatively coupled with the controllable switch device and configured to provide a third signal to the pedestrian detection system.

5. The system of claim 4, wherein the controllable switch device is configured to provide the second signal as a one-shot signal.

6. The system of claim 5, wherein the controllable switch device is configured to provide the second signal for a predetermined duration after initiation of the one-shot signal.

7. The system of claim 4, wherein a reverse blocking diode is provided intermediate the key switch and the controllable switch device.

8. The system of claim 1, wherein the controllable switch device comprises a relay.

9. The system of claim 8, wherein the relay comprises a programmable relay.

10. The system of claim 1, wherein the seat sensor comprises a seat switch.

11. The system of claim 1, wherein the work vehicle comprises a forklift.

12. A process comprising:
providing a system comprising a work vehicle including an operator seat and a seat sensor configured to sense presence of an operator seated in the operator seat, a pedestrian detection system including an electronic controller operatively coupled with one or more sensors and configured to detect presence of a pedestrian in proximity to the work vehicle, and a controllable switch device operatively coupled with the seat sensor and the pedestrian detection system;
providing a first signal from the seat sensor to the controllable switch device in response presence of an operator seated in the operator seat;
providing a second signal from the controllable switch device to the pedestrian detection system in response to the first signal; and
activating the pedestrian detection system in response to the second signal.

13. The process of claim 12, wherein the providing the second signal from the controllable switch device occurs in absence of a key on state of the work vehicle.

14. The process of claim 12, wherein the providing the second signal from the controllable switch device occurs during such time as the seat sensor provides the first signal and for a predetermined duration after such time.

15. The process of claim 12, comprising: providing a third signal from a key switch of the work vehicle to the pedestrian detection system.

16. The process of claim 15, wherein the second signal comprises a one-shot signal.

17. The process of claim 16, comprising providing the one-shot signal from the controllable switch device for a predetermined duration after initiation of the one-shot signal.

18. The process of claim 15, comprising providing a reverse blocking diode intermediate the key switch and the controllable switch device.

19. The process of claim 12, wherein the seat sensor comprises a seat switch.

20. The process of claim 12, wherein the work vehicle comprises a forklift.
